(19) United States
(12) Patent Application Publication
(10) Pub. No.: US 2025/0295269 A1
(43) Pub. Date: Sep. 25, 2025

(54) BRUSH TOOL AND FOOD PROCESSING APPLIANCE FOR CONVENIENT BLADE REMOVAL

(71) Applicant: OCOO Co., Ltd., Boryeong-si (KR)

(72) Inventor: Sun Qye Jung, Yongin-si (KR)

(21) Appl. No.: 19/000,269

(22) Filed: Dec. 23, 2024

(30) Foreign Application Priority Data
Mar. 21, 2024 (KR) 10-2024-0039357

(51) Int. Cl. A47J 43/07; A46B 5/00; A46B 15/00; A47J 43/046

(52) U.S. Cl. CPC A47J 43/0722; A46B 5/00; A46B 15/0055; A47J 43/046; A46B 2200/3033

(57) ABSTRACT

Disclosed is a brush tool and a food processing appliance for convenient blade removal. The present disclosure discloses a brush tool for cutter removal in a food processing appliance, which has a simple structure, enables both cleaning and cutter removal, is easy to operate, highly applicable, practical, reliable, and easy to maintain, and ensures hygiene and safety, and a food processing appliance including the brush tool.

### CROSS-REFERENCE TO RELATED APPLICATION(S)

This application is based on and claims priority under 35 U.S.C. 119 to Korean Patent Application No. 10-2024-0039357, filed on Mar. 21, 2024, in the Korean Intellectual Property Office, the disclosure of which is herein incorporated by reference in its entirety.

### BACKGROUND OF THE INVENTION

### 1. Field of the Invention

The present disclosure relates to a food processing appliance such as a porridge maker, a high-speed blender, a mixer, a heating mixer, and a soy milk maker. Specifically, the present disclosure relates to a brush tool for cutter removal in such a food processing appliance, and a food processing appliance using the same for convenient blade removal.

### 2. Description of the Prior Art

With the rapid development of the economy and society, food processing appliances have become widely used. These appliances are primarily divided into types such as slicers, which cut food ingredients (slicing, shredding, or dicing), juicers for extracting juice from fruits, and food processors for handling meat ingredients.

Regardless of the type, the structure of most food processing appliances generally includes a base assembly powered by a motor and a cup holder assembly equipped with a cutter. The cutter is connected to the output shaft of the motor through assembly components such as screws or nuts. The output shaft is driven by the motor to rotate the cutter, thereby implementing functions of crushing and mixing food ingredients.

Most food processing appliances are also equipped with a cleaning brush, which exists separately from the appliance itself and is disposable. In addition, since the blade is secured inside the container through cutter assembly components such as screws or bolts, food residues tend to accumulate behind the blade and in the area where the blade is assembled, making it difficult to clean the food residues thoroughly with a brush, which is undesirable for safety and hygiene. To achieve complete cleaning, a separate cutter removal tool is required to remove the blade, making the process cumbersome and leading to high maintenance costs.

In other words, conventional food processing appliances have the following disadvantages in practical application. That is, since the blade is secured within the container space through assembly components such as screws or bolts, food residues accumulate behind the blade and in the area where the blade is assembled, after use, making it difficult to clean thoroughly with a brush, which is undesirable for safety and hygiene. For complete cleaning, the blade should be removed. However, the blade rotates along with the motor's output shaft when removed, making removal difficult or even impossible. A special removal tool is required to secure the motor's output shaft, after which the blade can be removed, making the process cumbersome and leading to high maintenance costs.

### SUMMARY OF THE INVENTION

In view of the foregoing, the present disclosure is to provide a food processing appliance, which overcomes the problems of prior art, has a simple structure, enables convenient cutter removal, is easy to operation, practical, and convenient to clean, facilitates product maintenance, and ensures hygiene and safety. In addition, the present disclosure is to provide a brush tool for cutter removal in a food processing appliance, which overcomes the problems of prior art, has a simple structure, enables both cleaning and cutter removal, is easy to operate, highly applicable, practical, reliable, and easy to maintain, and ensures hygiene and safety.

Referring to FIGS. 1 to 14, a food processing appliance according to an aspect of the present disclosure includes a bottom lid 1; a cup body 2 having a cup space 21 at an upper portion to receive materials; and a motor 3 fixed to a lower portion of the cup body 2 and having a motor shaft 31, of which an upper portion extends into the cup space 21 of the cup body 2 through a bottom wall of the cup body 2; and a removable blade 4 screw-connected to an upper portion of the motor shaft 31. The motor shaft 31 is provided with a positioning portion 311 in the lower portion thereof, the bottom lid 1 is provided with a removable locking cover 5, and the locking cover 5 is provided with a locking portion 51 configured to receive and lock the positioning portion 311 of the lower portion of the motor shaft 31.

The food processing appliance further includes a removal tool 6, the blade 4 is provided with a screw 7 screw-coupled to the upper portion of the motor shaft 31, and the removal tool is provided with an opening 61 configured to receive a head of the screw 7 of the blade 4 or a jaw 62 configured to engage with the blade 4.

The bottom lid 1 is provided with an alcove 11 configured to receive the locking cover 5 and prevent the locking cover 5 from shaking.

The bottom lid 1 may be provided with a control circuit board 8 and a magnetic inductive switch 9, and the magnetic inductive switch 9 and the motor 3 may each be electrically connected to the control circuit board 8.

One end of the locking cover 5 may include a first magnet 10 capable of controlling the opening and closing of the magnetic inductive switch 9.

The bottom lid 1 may be provided with a control circuit board 8 and a micro switch 81, which is triggered and deactivated by a locking portion 51, and the micro switch 81 and the motor 3 may each be electrically connected to the control circuit board 8.

The locking portion 51 may include a protruding wall 52 configured to trigger and deactivate the micro switch 81.

The cross-section of the positioning portion 311 at the lower portion of the motor shaft 31 may have a “straight,” “cross,” “triangular,” “rectangular,” “square,” “hexagonal,” or “plum blossom” shape.

The cross-sectional shape of the locking portion 51 may be identical or similar to the cross-sectional shape of the positioning portion 311.

The cross-section of the head of the screw 7 may have a shape such as a “straight,” “cross,” “triangular,” “rectangular,” “square,” “hexagonal,” or “plum blossom” shape.

The cross-sectional shape of the opening 61 of the removal tool may be identical or similar to the cross-sectional shape of the head of the screw 7.

The bottom lid 1 may be provided with an iron block 12, the locking cover 5 may be correspondingly provided with a first magnet 10 and a second magnet 13 configured to attract the iron block 12, and the first magnet 10 and the locking portion 51 may be symmetrically distributed on both sides of the second magnet 13.

The bottom lid 1 may be provided with a third magnet 14, the locking cover 5 may be provided with a first magnet 10 and a second magnet 13 configured to attract the third magnet 14, and the first magnet 10 and the locking portion 51 may be symmetrically distributed on both sides of the second magnet 13.

Grooves 17 may be provided on both sides of the locking cover 5.

The bottom lid 1 may include two hollow portions 15 configured to respectively receive the locking portion 51 and the first magnet 10.

The bottom lid 1 may also include a cavity 16 configured to receive the second magnet 13.

One end of the removal tool may be a brush head 63, and the opening 61 or the jaw 62 may be provided at the other end of the removal tool.

In addition, referring to FIGS. 15 to 25, a brush tool for cutter removal in a food processing appliance according to another aspect of the present disclosure includes a cleaning brush for cleaning the food processing appliance, and the cleaning brush includes a brush head 63 and a brush handle 6. The brush handle 6 has at one end a removal member configured to remove the blade of a blade assembly structure 115. The removal member may include a detachable hollow portion 114, and the blade of the blade assembly structure 115 is mounted or removed by fitting the detachable hollow portion 114 onto the blade assembly structure 115 and rotating the blade assembly structure 115 along with the brush handle 6.

The detachable hollow portion 114 may include an opening 61 configured to receive the head of the screw 7 of the blade 4 or the jaw 62 configured to engage with the blade 4.

The detachable hollow portion 114 includes at the upper portion a magnet block 116 for magnetic attraction connection between the blade 4 and the blade assembly structure 115.

The magnet block 116 is built into the inside of the brush handle 6.

The blade assembly structure 115 may include a nut 151 assembled to the blade 4, and the detachable hollow portion 114 is configured to match the shape of the nut 151. The nut 151 is mounted or removed by fitting the detachable hollow portion 114 onto the nut 151 and rotating the nut 151.

The blade assembly structure 115 may include a screw 152 assembled to the blade 4, and the detachable hollow portion 114 is configured to match the shape of the head of the screw 152. The screw 152 is mounted or removed by fitting detachable hollow portion 114 onto the head of the screw 152 and rotating the screw 152.

The blade assembly structure 115 may include a blade mounting portion 153 integrated with the blade 4, and the detachable hollow portion 114 may be configured to match the shape of the blade mounting portion 153. The blade 4 is mounted or removed by fitting the detachable hollow portion 114 onto the blade mounting portion 153 and rotating the blade 4.

The other end of the brush handle 6 may be provided as an L-shaped handle, the brush head 63 may be provided in an L-shape, and the L-shaped brush head 63 may be provided on the L-shaped handle.

The advantages of the food processing appliance of the present disclosure are as follows.

1) When separating the blade through the structural coupling of the positioning portion at the lower portion of the motor shaft and the locking portion of the locking cover, the locking portion is fixed to the positioning portion of the motor shaft by rotating the locking cover at the base to lock the motor shaft, thereby preventing the blade from rotating during operation and facilitating removal of the blade. Once the blade removal is complete, the locking cover is rotated again to separate the locking portion and the positioning portion, and the motor shaft is unlocked, allowing for easy operation, convenient cleaning, and simple maintenance and replacement, ensuring hygienic and safe use of the product.

2) By coupling the control circuit board with the magnetic inductive switch, when the motor shaft is in the locked state, the magnetic inductive switch is open, causing the control circuit board and the motor to stop operating, and when the motor shaft is in the unlocked state, the magnetic inductive switch is closed, allowing the control circuit board and the motor to operate normally. Thus, the structure is stable, the safety performance during use is enhanced, and the product quality is assured.

3) The cleaning brush of the present disclosure can be used not only as a cleaning tool but also as a blade removal tool, making it convenient to operate, versatile, practical, and reliable. Furthermore, using the cleaning brush as a removal tool enables safe use by preventing hand injuries while removing the blade.

4) By adding the removal member to the brush tool (or removal tool) in this structure, at the time of cleaning, the blade assembly structure and blade can be separated by fitting the detachable hollow portion of the removal member onto the blade assembly structure and rotating the brush, eliminating the need for a separate cutter removal tool, facilitating easy operation, and allowing the brush to be used for both cleaning and cutter removal, thereby providing flexibility and strong applicability.

5) Since the magnet block is built in, the brush tool (or removal tool) in this structure can magnetically attract the blade and the blade assembly structure when separated, allowing for easy separation, positioning, simplifying the process, and preventing loss, and ensuring practicality and reliability.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a structural view of a locked state according to a first embodiment of the present disclosure;

FIG. 2 is a cross-sectional view of the locked state according to the first embodiment of the present disclosure;

FIG. 3 is a partial exploded view of the locked state according to the first embodiment of the present disclosure;

FIG. 4 is a structural view of the unlocked state according to the first embodiment of the present disclosure;

FIG. 5 is a cross-sectional view of the unlocked state according to the first embodiment of the present disclosure;

FIG. 6 is a partial exploded view of the unlocked state according to the first embodiment of the present disclosure;

FIG. 7 is a structural view according to the first embodiment of the present disclosure (with a bottom lid removed);

FIG. 8 is a structural diagram of a locking cover according to the first embodiment of the present disclosure;

FIG. 9 is a structural view of a blade according to the first embodiment of the present disclosure;

FIG. 10 is a structural view of a cleaning brush according to the first embodiment of the present disclosure;

FIG. 11 is a cross-sectional view according to a second embodiment of the present disclosure;

FIG. 12 is a structural view of a cleaning brush according to the second embodiment of the present disclosure;

FIG. 13 is a cross-sectional view according to a third embodiment of the present disclosure;

FIG. 14 is a structural view of a locking cover of FIG. 13;

FIG. 15 is a cross-sectional view according to the first embodiment of the present disclosure;

FIG. 16 is an enlarged view of area A of FIG. 15 according to the first embodiment of the present disclosure;

FIG. 17 is a structural view of a blade assembly structure and a blade according to the first embodiment of the present disclosure;

FIG. 18 is a cross-sectional view according to the second embodiment of the present disclosure;

FIG. 19 is an enlarged view of area B of FIG. 18 according to the second embodiment of the present disclosure;

FIG. 20 is a structural view of a blade assembly structure and a blade according to the second embodiment of the present disclosure;

FIG. 21 is a structural view of a cleaning brush according to the second embodiment of the present disclosure;

FIG. 22 is a cross-sectional view according to a third embodiment of the present disclosure;

FIG. 23 is an enlarged view of area C of FIG. 22 according to the third embodiment of the present disclosure;

FIG. 24 is an exploded view of the cleaning blush, the blade assembly structure, and the blade according to the third embodiment of the present disclosure; and

FIG. 25 is an exploded view of the cleaning blush, the blade assembly structure, and the blade according to the third embodiment of the present disclosure when viewed from another angle.

### DETAILED DESCRIPTION OF THE EXEMPLARY EMBODIMENTS

Hereinafter, the present disclosure will be described in detail with reference to the accompanying drawings. Herein, like components in each drawing are denoted by like reference numerals if possible. In addition, detailed descriptions of already known functions and/or configurations will be omitted. In the following description, components necessary for understanding operations according to various embodiments will be mainly described, and descriptions of elements that may obscure the gist of the description will be omitted. In addition, some elements in the drawings may be exaggerated, omitted, or schematically illustrated. The size of each component does not entirely reflect the actual size. Therefore, the descriptions provided herein are not limited by the relative sizes or spacings of the components drawn in each drawing.

In describing the embodiments of the present disclosure, when a detailed description of the known technology related to the present disclosure is determined to unnecessarily obscure the subject matter of the present disclosure, the detailed description will be omitted. In addition, terms to be described later are defined in consideration of functions in the present disclosure, and may vary according to the intention, custom, or the like of a user or operator. Therefore, the definitions of the terms should be made based on the description throughout this specification. Terms used in the detailed description are only for describing the embodiments of the present disclosure, and should not be construed as limiting in any way. Unless expressly used otherwise, singular expressions include the meanings of plural expressions. As used herein, expressions such as “including” or “comprising” are intended to indicate any features, numbers, steps, operations, elements, or some or combinations thereof, and should not be construed to exclude the existence or possibility of one or more other features, numbers, steps, operations, elements, or some or combinations thereof, in addition to those described above.

In addition, terms such as “first” and “second” may be used to describe various components, but the components are not limited by the terms, and these terms are only used for the purpose of distinguishing one component from another.

First, a food processing appliance (or food processor) according to an embodiment of the present disclosure, as described below, may include various devices capable of grinding materials within a container (cup) using a blade, such as a porridge maker, high-speed blender, mixer, heating mixer, soy milk maker, or juicer. In addition, the food processing appliance according to an embodiment of the present disclosure may include a heater (not illustrated) at the bottom of the container to heat the material to be ground. The heater (not illustrated) may be a type heated using a heating wire or a heating element in addition to an induction heating-type heater. Preferably, the heater (not illustrated) may include an induction heating-type induction coil provided under the container. The control device (not illustrated) of the food processing appliance may control power supply to the induction coil. In addition, the control device (not illustrated) of the food processing appliance may perform overall control for operations such as crushing by the food processing appliance and the operation of the heater.

Hereinafter, the present disclosure is described in more detail with reference to the drawings.

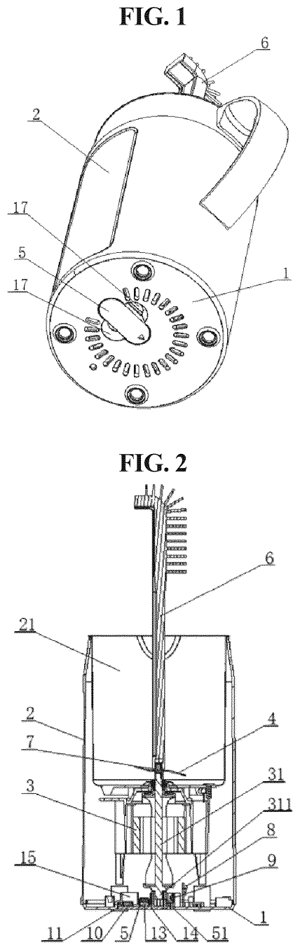

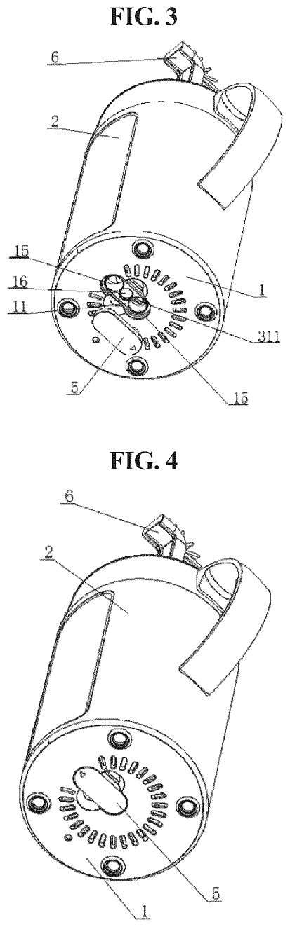

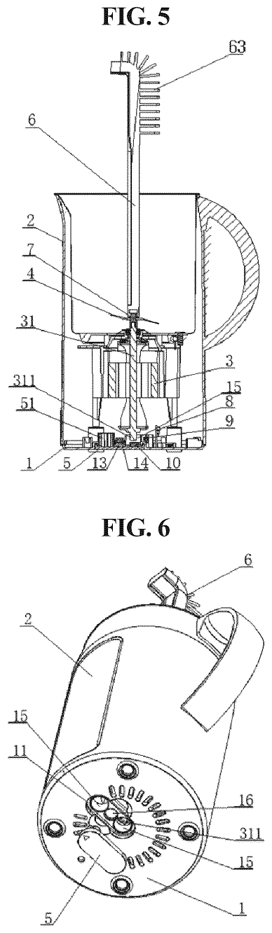

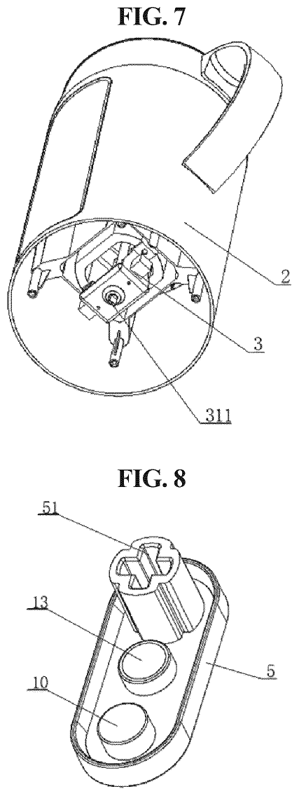

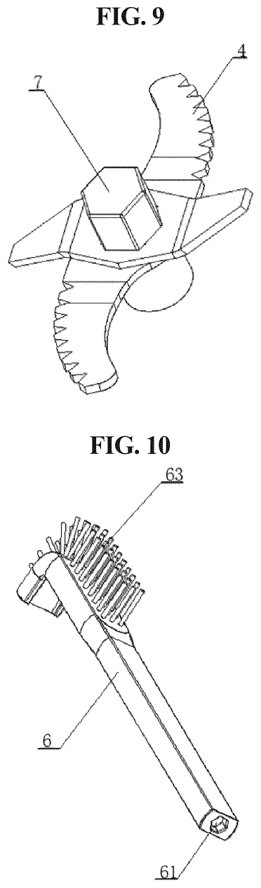

As illustrated in FIGS. 1 to 10, a food processing appliance for convenient blade removal according to the present disclosure includes: a bottom lid 1; a cup body 2 having a cup space 21 provided at an upper portion thereof to receive materials; and a motor 3 fixed to a lower portion of the cup body 2 and having a motor shaft 31, of which an upper portion extends into the cup space 21 of the cup body 2 through a bottom wall of the cup body 2; and a removable blade 4 screw-connected to an upper portion of the motor shaft 31. Here, the motor shaft 31 is provided with a positioning portion 311 at the lower portion thereof, and the bottom lid 1 is provided with a removable locking cover 5, and the locking cover 5 is provided with a locking portion 51 configured to receive and lock the positioning portion 311 of the lower portion of the motor shaft 31.

In addition, the bottom lid 1 is provided with an iron block 12, the locking cover 5 is correspondingly provided with a first magnet 10 and a second magnet 13 configured to attract the iron block 12, and the first magnet 10 and the locking portion 51 are symmetrically distributed on both sides of the second magnet 13.

The bottom lid 1 is provided with a control circuit board 8 and a magnetic inductive switch 9, and the magnetic inductive switch 9 and the motor 3 are each electrically connected to the control circuit board 8. One end of the locking cover 5 includes a first magnet 10 capable of controlling the opening and closing of the magnetic inductive switch 9.

Both sides of the locking cover 5 are provided with grooves 17 for convenient operation.

That is, when removing the blade 4, when a hand is inserted into the grooves 17, then lifts up the locking cover 5 upward, and rotates the locking cover 5, and when the locking cover is rotated to a predetermined position, the positions of the first magnet 10 and the locking portion 51 are aligned, causing the locking portion 51 to engage with the positioning portion 311 at the lower portion of the motor shaft 31. At the same time, the magnetic attraction between the second magnet 13 and the iron block 12 firmly fixes the locking portion 51 to the positioning portion 311 at the lower portion of the motor shaft 31, so that the motor shaft 31 is locked. As a result, the blade 4 is prevented from rotating during operation, and the blade 4 is easily removed.

At this time, since the first magnet 10 moves away from the magnetic inductive switch 9, the magnetic inductive switch 9 is deactivated, causing the control circuit board 8 and the motor 3 to stop operation.

After removing the blade 4, the locking cover 5 is similarly rotated to separate the locking portion 51 from the positioning portion 311, thereby unlocking the motor shaft 31. When rotated to the predetermined position, the first magnet 10 and the locking portion 51 return to their original positions and align. The first magnet 10 is magnetically attracted to and connected with the magnetic inductive switch 9, causing the magnetic inductive switch 9 to close and supply power to the control circuit board 8 and the motor 3, allowing the motor to operate normally. Thus, the structure is stable, the safety performance during use is enhanced, and the product quality is assured.

In actual use, the bottom lid 1 is provided with a third magnet 14, the locking cover 5 is correspondingly provided with a second magnet 13 configured to attract the third magnet 14, and the first magnet 10 and the locking portion 51 are symmetrically distributed on both sides of the second magnet 13. In this way, by strengthening the magnetic force by using the third magnet 14 instead of the iron block 12, the motor shaft 31 can be locked during the removal, thereby improving the structural stability during the removal.

As illustrated in FIGS. 1 to 10, more specifically, the cross-section of the positioning portion 311 at the lower portion of the motor shaft 31 may have a “straight,” “cross,” “triangular,” “rectangular,” “square,” “hexagonal,” or “plum blossom” shape. The cross-sectional shape of the locking portion 51 is identical or similar to the cross-sectional shape of the positioning portion 311.

In the drawings, only the case where the cross-section of the positioning portion 311 at the lower portion of the motor shaft 31 has a “straight” shape, and the cross-sectional shape of the locking portion 51 matches this “straight” shape, is illustrated.

By using the locking portion 51 and the positioning portion 311 with this structure, the structure may be simplified and the locking structure may be strengthened, making the blade 4 removal process easy, practical, and reliable.

The bottom lid 1 includes an alcove 11 configured to receive the locking cover 5 and prevent the locking cover 5 from shaking, two hollow portions 15 configured to respectively receive the locking portion 51 and the first magnet 10, and a cavity 16 configured to receive the second magnet 13.

By the structure of the alcove 11, the hollow portions 15, and the cavity 16, the structure is compact, the structural integrity is strengthened, and not only the structural performance but also the appearance of the product is assured.

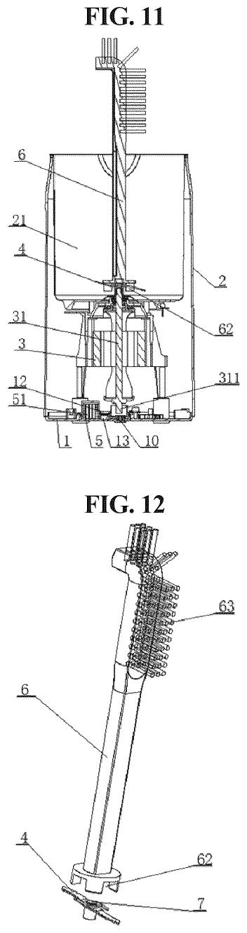

As illustrated in FIGS. 1 to 12, more specifically, the food processing appliance further includes a cleaning brush 6 that serves as a cleaning tool and a removal tool. The blade 4 is provided with a screw 7 screw-coupled to the upper portion of the motor shaft 31, and the cleaning brush 6 is provided with an opening 61 configured to receive the head of the screw 7 of the blade 4 or a jaw 62 configured to engage with the blade 4. Here, one end of the cleaning brush 6 is a brush head 63, while the opening 61 or the jaw 62 is provided at the other end of the cleaning brush 6.

During use, the screw 7 may be installed separately from the blade 4 or integrally with the blade 4. Accordingly, the cleaning brush 6 is provided with a corresponding opening 61 or a jaw 62 that engages with the blade 4.

The cross-section of the head of the screw 7 has a “straight,” “cross,” “triangular,” “rectangular,” “square,” “hexagonal,” or “plum blossom” shape. The cross-sectional shape of the opening 61 of the cleaning brush 6 is identical or similar to the cross-sectional shape of the head of the screw 7.

When removing the blade 4, the motor shaft 31 is in the locked state. By fastening the cleaning brush 6 to the screw 7 using the opening 61 or fastening the jaw 62 to the blade 4, and then rotating the screw 7 or the blade 4, the screw 7 or the blade 4 is removed.

The cleaning brush 6 of this product may be used not only as a cleaning tool but also as a blade 4 removal tool, making it simple in structure, convenient to operate, versatile, practical, and reliable.

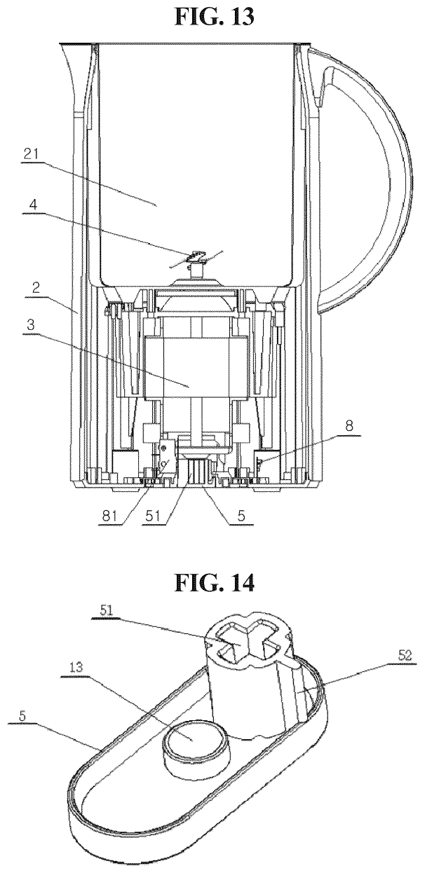

As shown in FIGS. 13 and 14, a food processing appliance according to a third embodiment of the present disclosure has the following differences from the food processing appliance of the first embodiment. A micro switch 81 is used instead of the magnetic inductive switch 9, and the locking cover 5 does not need to include the first magnet 10. The micro switch 81 is installed on the bottom lid 1, and the micro switch 81 and the motor 3 are each electrically connected to the control circuit board 8. The locking portion 51 is provided with a protruding wall 52 that triggers and deactivates the micro switch 81. When the locking portion 51 of the locking cover 5 is firmly locked to the positioning portion 311 at the lower portion of the motor shaft 31, the protruding wall 52 of the locking portion 51 deactivates the micro switch 81. When the locking cover 5 is removed, the protruding wall 52 of the locking portion 51 no longer triggers the micro switch 81, allowing the micro switch 81 to close, so that the food processing appliance is supplied with power and operates. After being removed, the locking cover 5 may be rotated 180 degrees and secured to the bottom lid 1. When the locking cover 5 is rotated 180 degrees and then secured to the bottom lid 1, the locking portion 51 is not locked to the lower portion of the motor shaft 31 any longer. Thus, the protruding wall 52 does not trigger the micro switch 81, and the micro switch 81 closes, so that the food processing appliance is supplied with power and operates. In this embodiment, since the remaining structure and beneficial effects are identical to those of the first embodiment, further explanation is omitted here.

So far, the food processing appliance of the present disclosure has been described as having a simple structure, enabling convenient cutter removal, being easy to operate, practical, and convenient to clean, facilitating product maintenance, and ensuring hygiene and safety.

The following provides a more detailed description of the brush tool (or removal tool), for example, including the brush handle 6 and the brush 63 for cutter removal in the food processing appliance of the present disclosure. The present disclosure is able to provide a brush tool 6 and 63 for cutter removal in a food processing appliance, which has a simple structure, enables both cleaning and cutter removal, is easy to operate, highly applicable, practical, reliable, and easy to maintain, and ensures hygiene and safety.

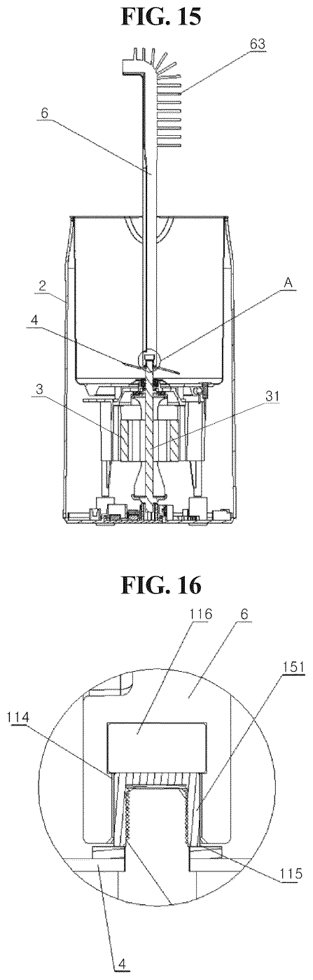

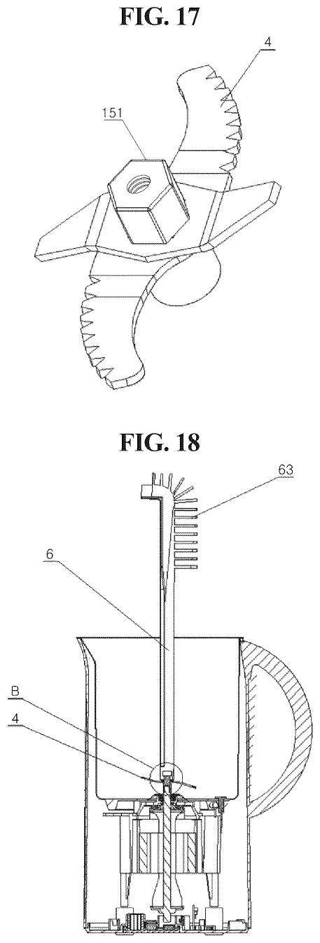

According to FIGS. 15 to 17 and 21, the brush tool for cutter removal in the food processing appliance of the present disclosure includes a cleaning brush for cleaning the food processing appliance, and the cleaning brush includes a brush head 63 and a brush handle 6. The brush handle 6 is provided with a removal member at one end thereof to remove the blade assembly structure 115, and this removal member includes a detachable hollow portion 114. The blade assembly structure 115 is mounted or removed by fitting the detachable hollow portion 114 onto the blade assembly structure 115 and rotating the blade assembly structure 115 along with the brush handle 6.

In practical application, the blade assembly structure 115 includes a nut 151 assembled with the blade 4, and the detachable hollow portion 114 is shaped to match the shape of the nut 151. The specific shape of the hollow portion may be configured as a “circular,” “straight,” “cross,” “triangular,” “rectangular,” “square,” “quadrangular,” “hexagonal”, or “plum blossom” shape. By fitting the detachable hollow portion 114 onto the nut 151 and rotating the nut 151, the nut 151 is mounted or removed.

By adding the removal member to the brush tool of this structure, at the time of cleaning, the blade assembly structure 115 and the blade 4 are separated by fitting the detachable hollow portion 114 of the removal member onto the blade assembly structure 115 and then rotating the brush, eliminating the need for a separate cutter removal tool, facilitating easy operation, and allowing the brush to be used both for cleaning and cutter removal, thereby providing flexibility in use and strong applicability.

As illustrated in FIGS. 15 to 17 and 21, a magnetic block 116 is provided at the upper portion of the detachable hollow portion 114 for magnetic attractive connection with the blade 4 and blade assembly structure 115. The magnet block 116 is built into the inside of the brush handle 6.

Since the magnetic block 116 is built in, the brush tool in this structure magnetically attracts the blade 4 and the blade assembly structure 115 when separated, allowing for easy separation, positioning, simplifying operation, preventing loss, and ensuring practicality and reliability.

In addition, the other end of the brush handle 6 is provided as an L-shaped handle, the brush head 63 may be provided in an L-shape, and the L-shaped brush head 63 may be provided on the L-shaped handle.

By combining the structure of the L-shaped handle and the L-shaped brush head 63, the operation of the brush tool becomes easier, allowing the brush to reach even the gaps in the space inside the container, thereby improving cleanliness and enhancing hygiene safety.

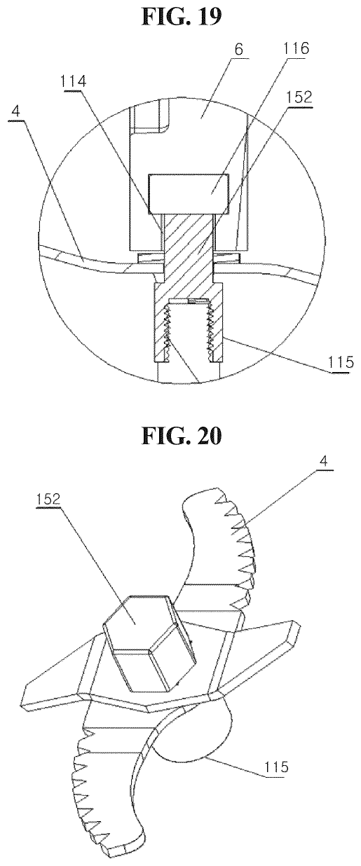

As illustrated in FIGS. 18 to 21, another embodiment is distinguished from the previous embodiments in that the blade assembly structure 115 includes a screw 152 assembled to the blade 4, and the detachable hollow portion 114 matches the shape of the head of the screw 152. The specific shape of the hollow portion may be configured as a “circular”, “straight”, “cross”, “triangular”, “rectangular”, “square”, “quadrangular”, “hexagonal”, or “plum blossom” shape, or the like. By fitting the detachable hollow portion 114 onto the head of the screw 152 and rotating the screw 152, the screw 152 is mounted or removed.

The detachable hollow portion 114 may include an opening 61 configured to receive the head of the screw 7 of the blade 4 or the jaw 62 configured to engage with the blade 4.

Since the screw 152 is removed by fitting the detachable hollow portion 114 using the brush tool onto the head of the screw 152 and rotating the brush tool, and no separate removal tool is required, this structure is easy to operate, enabling the brush to be used both for cleaning and removing the cutter, providing flexibility in use and strong applicability.

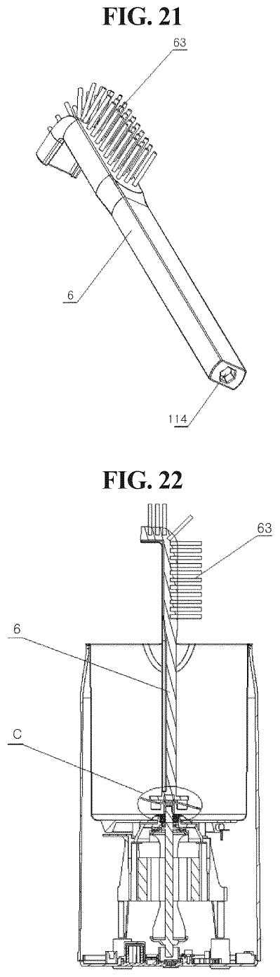

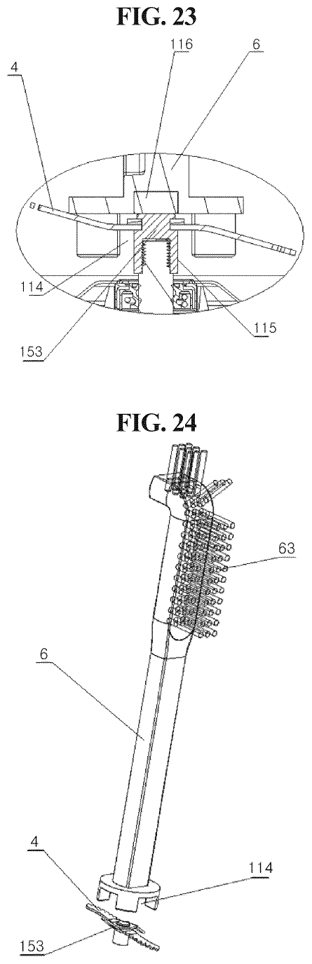

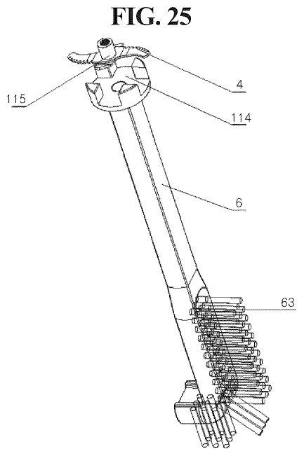

As illustrated in FIGS. 22 to 24, another embodiment is distinguished from the previous embodiments in that the blade assembly structure 115 includes a blade mounting portion 153 configured integrally with the blade 4, and the detachable hollow portion 114 is configured to match the shape of the blade mounting portion 153. The specific structure of the hollow portion may be implemented as a cross-shaped hollow portion, and the other end of the brush is configured in a hook shape, as illustrated in FIG. 20. Thus, the blade 4 is mounted or removed by fitting the detachable hollow portion 14 onto the blade mounting portion 153 and rotating the blade 4.

Since the blade 4 is removed by fitting the detachable hollow portion 114 using the brush tool onto the blade mounting portion 153 and rotating the brush tool, and no separate removal tool is required, this structure is easy to operate, enabling the brush to be used both for cleaning and removing the cutter, providing flexibility in use and strong applicability.

In the foregoing, the present disclosure has been described based on specific details, such as concrete components, limited embodiments, and drawings, but these have been provided merely to aid a more comprehensive understanding of the present disclosure, and the present disclosure is not limited to the above-described embodiments. Various modifications and alterations may be made without departing from the essential characteristics of the present disclosure by a person ordinarily skilled in the art to which the present disclosure pertains. Therefore, the spirit of the present disclosure should not be limited to the described embodiments, and not only the appended claims, but also all technical ideas that are equivalent or have equivalent modifications to the claims should be construed as being included within the scope of the present disclosure.

What is claimed is:

1. A food processing appliance comprising:
a bottom lid;
a cup body having a cup space provided at an upper portion thereof to receive materials;
a motor fixed to a lower portion of the cup body and having a motor shaft, of which an upper portion extends into the cup space of the cup body through a bottom wall of the cup body;
a removable blade screw-connected to an upper portion of the motor shaft; and
a removal tool,
wherein the blade is provided with a screw or a nut screw-coupled to the upper portion of the motor shaft, and the removal tool is provided with an opening configured to receive a head of the screw of the blade or a jaw configured to engage with the blade.

2. The food processing appliance of claim 1, wherein the motor shaft is provided with a positioning portion at the lower portion thereof, the bottom lid is provided with a removable locking cover, the locking cover is provided with a locking portion configured to receive and lock the positioning portion of the lower portion of the motor shaft.

3. The food processing appliance of claim 1, wherein the bottom lid is provided with an alcove configured to receive the locking cover and prevent the locking cover from shaking.

4. The food processing appliance of claim 1, wherein the bottom lid is provided with an iron block or a third magnet, the locking cover is correspondingly provided with a first magnet and a second magnet configured to attract the iron block or the third magnet, and the first magnet and the locking portion are symmetrically distributed on both sides of the second magnet.

5. A brush tool for removing a cutter of a food processing appliance, the brush tool comprising:
a cleaning brush configured to clean the food processing appliance and comprising a brush head and a brush handle,
wherein the brush handle has at one end a removal member configured to remove a blade of a blade assembly structure, the removal member comprises a detachable hollow portion, and the blade of the blade assembly structure is mounted or removed by fitting the detachable hollow portion onto the blade assembly structure and rotating the blade assembly structure along with the brush handle, and
wherein the detachable hollow portion comprises an opening to receive a head of the screw of the blade or the jaw configured to engage with the blade.

6. The brush tool of claim 5, wherein the detachable hollow portion comprises at upper portion a magnet block for magnetic attraction connection between the blade and the blade assembly structure.

7. The brush tool of claim 5, wherein the blade assembly structure comprises a screw assembled to the blade or a blade mounting portion integrally formed with the blade, the detachable hollow portion is configured to match a shape of the head of the screw or the blade mounting portion, and the screw or blade is mounted or removed by fitting the detachable hollow portion onto the head of the screw or the blade mounting portion and rotating the screw or the blade.
